(19) United States
(12) Patent Application Publication
(10) Pub. No.: US 2024/0191150 A1
(43) Pub. Date: Jun. 13, 2024

(54) An Improved Updraft Gasifier and Methods of Use

(71) Applicant: Hot Lime Labs Limited, Gracefield, Lower Hutt (NZ)

(72) Inventors: Vlatko Materic, Mount Victoria, Wellington (NZ); Douglas Brian Williams, Gracefield, Lower Hutt (NZ)

(21) Appl. No.: 18/556,335

(22) PCT Filed: Apr. 19, 2022
(86) PCT No.: PCT/NZ2022/050044

§ 371 Date: Oct. 19, 2023

(30) Foreign Application Priority Data
Apr. 19, 2021 (NZ) 775177

(51) Int. Cl. C10J 3/32; C10J 3/06; C10J 3/30; C10J 3/40

(52) U.S. Cl. CPC C10J 3/32; C10J 3/06; C10J 3/30; C10J 3/40; C10J 2200/152; C10J 2200/158; C10J 2300/0916

(57) ABSTRACT

An updraft gasifier including a reactor chamber, the chamber adapted to receive an amount of biomass fuel, one or more reaction gas input means, the base portion located below and fluidly connected to the receiving portion of the reactor chamber, a hollow feed tube extending into the receiving portion of the chamber to terminate at a feed tube terminus within the receiving portion of the chamber, one or more product gas output means located at or near the top of the receiving portion of the reactor chamber; and wherein the gasifier further includes a biomass distribution member within the receiving chamber, the biomass distribution member positioned to enable a portion of the distribution member to be moveable beneath the feed tube terminus.

### FIELD OF INVENTION

This invention relates to an updraft gasifier and method for its use. More specifically it relates to an updraft gasifier with gravity feeding and a biomass distribution member to maintain biomass pile shape within the reactor. Also provided are methods for the production of product gas and charcoal.

### BACKGROUND TO THE INVENTION

Gasifiers are used to convert high-carbon fuel to produce any combination of combustible gases, oils, tars, charcoal, slag, and ash depending on the gasifier design and operation.

Updraft gasifiers, also known as counter-current gasifiers, operate by a carbonaceous fuel (typically biomass or coal) moving downward through a gasifier, with gasifying air fed upward through the base of the gasifier and through the fuel. Combustion of the biomass occurs in the lower regions of the gasifier, the “combustion zone”, raising the temperature inside the gasifier. Hot gases produced in the combustion zone pass upward through the bed of downflowing biomass and are reduced in the zone immediately above the combustion zone. Following reduction of the hot gases, pyrolysis of the biomass occurs, and the biomass is dried further towards the top of the gasifier, leading to the production of synthesis gas of a relatively low temperature.

A wide range of updraft gasifiers are available and known in the art.

US384151 describes an updraft gasifier where solid waste is delivered to a hopper then conveyed into a gasification reactor using a ram box to compress fuel into a non-porous, de-aired bundle, then move the fuel through a feeder where particles of fuel as disengaged and dropped onto a fuel distributor. The fuel is then distributed in a dome shape within the reactor and reacted with an oxygen-containing gas in a melting zone, converting the organic matter into a gas, and melting the in-organic matter for disposal in solid form. Gases produced may be further treated in a second chamber to remove unwanted volatiles for future use as a synthesis gas or clean fuel.

EP1129154 discloses a method for gasifying carbon containing fuels in a fixed-layer gasifier. Carbon based fuel is introduced centrally to a gasification reactor using a screw conveyor delivering fuel down a central feed tube.

One of the problems with known gasifiers is that they are developed to work specifically either on a large scale, or with a specific fuel type and size. With smaller gasifiers it can be difficult to keep gasification steady without the requirement for advanced controls managing the incoming fuel. The use of a range of different biomass, which is particularly beneficial from a commercial perspective, may also cause issues with known gasifiers, with variations in biomass size and moisture content unable to be catered for by the mechanical limitations of many systems.

### OBJECT OF THE INVENTION

It is an object of the invention to provide an updraft gasifier for producing gas from a wide range of feedstock.

Alternatively, it is an object to provide a method for feeding a gasifier using a gravity fed feed tube system with a biomass distribution member.

Alternatively, it is an object of the invention to provide a method for producing product gas and/or charcoal.

Alternatively, it is an object of the invention to at least provide the public with a useful choice.

### SUMMARY OF THE INVENTION

According to a first aspect of the invention, there is provided an updraft gasifier, the gasifier including;
a reactor chamber, the chamber adapted to receive an amount of biomass fuel in a receiving portion of the chamber;
one or more reaction gas input means located in a base portion of the chamber, the base portion located below and fluidly connected to the receiving portion of the reactor chamber;
a hollow feed tube extending into the receiving portion of the chamber to terminate at a feed tube terminus within the receiving portion of the chamber;
one or more product gas output means located at or near the top of the receiving portion of the reactor chamber; and
   wherein the gasifier further includes a biomass distribution member within the receiving chamber, the biomass distribution member positioned to enable a portion of the distribution member to be moveable beneath the feed tube terminus.

In preferred embodiments, the reactor chamber receiving portion and base portion are separated by a shelf.

Preferably, the shelf includes one or more apertures, the one or more apertures fluidly connecting the receiving portion and the base portion. More preferably, the shelf includes a single aperture located beneath the centre of the feed tube terminus.

In further embodiments, the gasifier includes a cover associated with the aperture such as a hatch, grate, grille or door that may be fully or partially opened to allow material to move between the receiving portion and base portion or fully or partially closed to prevent or restrict movement of material between the receiving portion and base portion

Preferably, the cover is a rotating door mechanism positioned at least partially below the aperture. More preferably, the rotating door mechanism is rotatable around a central axis and includes a hollow body with a plurality of fins extending radially outward from the hollow body.

More preferably, one or more of the plurality of fins and the hollow body includes apertures to allow gas, ash or char to pass through the fin or hollow body.

In preferred embodiments, the shelf includes one or more including a mechanical opening such as a hatch, door, rotary valve or slide gate valve that may be opened and closed to enable additional charcoal or ash extraction from the receiving portion or the reactor.

More preferably, mechanical opening is a rotating extractor connecting the receiving chamber and base chamber.

Preferably, the distance between the feed tube terminus and shelf is at least 200 mm, more preferably 200 mm-800 mm, and even more preferably, 300 mm-500 mm.

Preferably, the feed tube is substantially vertical.

In further preferred embodiments, the feed tube has a diameter of between 100-400 mm. More preferably, the feed tube has a diameter of 200 mm.

In preferred embodiments, the feed tube has a length of between 400-800 mm.

Preferably, the feed tube includes a central vertical screw feed.

In further embodiments, the receiving portion of the reactor chamber includes a baffle for directing gas flow within the receiving portion. More preferably, the baffle is in the form of a ledge extending from the feed tube to the reactor wall, the baffle positioned substantially perpendicular to the vertical feed tube and reactor wall.

In preferred embodiments the reactor is vertically cylindrical or cuboid and the baffle covers between 65-35% of the horizontal cross sectional area of the cylinder.

Preferably, the biomass distribution member is movable in a horizontal plane, perpendicular to the vertical axis of the feed tube.

In one embodiment, the biomass distribution member is connected to the central vertical screw feed in the feed tube.

Alternatively, the biomass distribution member pivots around a fulcrum offset from the central vertical axis of the reactor chamber.

Alternatively, the biomass distribution member extends and retracts from a position offset from the central vertical axis of the reactor chamber.

Preferably, the biomass distribution member includes a blade portion.

More preferably, the biomass distribution member includes a vertical shaft rotatable around the vertical axis of said shaft, the shaft extending into the receiving portion of the chamber parallel to the vertical feed tube and a blade portion connected to the shaft, the blade portion shaped such that the blade extends from the shaft at an angle such that when the shaft is rotated, the blade portion is moved beneath the feed tube terminus.

Even more preferably, the blade portion is an elongate paddle. In a preferred embodiment, the blade portion is angled at one or more locations along the elongate paddle, such that a region of the blade is positioned horizontally beneath the feed tube terminus.

In alternative embodiments, the biomass distribution member includes a tube, channel or recess. Even more preferably the biomass distribution member has a U-shaped, D-shaped or V-shaped cross section.

In further embodiments, the gasifier includes a means to introduce gas along the biomass distribution member.

In further preferred embodiments the gas input means is one or more gas injection nozzles centrally located in the base portion of the reactor chamber. Preferably, the gas injection nozzle is vertically aligned with the shelf aperture and the centre of the feed tube to direct reaction gas vertically upward through the aperture into the receiving portion of the reactor.

In further embodiments, the gas input means include a central gas injection nozzle surrounded by eight gas injection nozzles.

According to a further embodiment of the invention, there is provided a method for the production of product gas in an updraft gasifier, the method including;
a) introducing biomass fuel into a substantially hollow vertical feed tube, the feed tube extending into a reactor chamber to terminate at a feed tube terminus within the chamber to produce a fuel pile within the chamber;
b) introducing a reaction gas from below the fuel pile to react with the fuel in the pile to produce a product gas;
c) maintaining the shape of the fuel pile within the reactor using a biomass distribution member to enforce the shape of the fuel pile;
d) removing the product gas from the reactor chamber;
   wherein steps a)-d) are continuously repeated, either simultaneously or individually.

Preferably, the upper surface of the fuel pile is maintained in a frustoconical shape. More preferably, the upper surface of the fuel pile is maintained in a frustoconical shape having angled sides of 40-55 [symbol] .

Preferably, the step of maintaining the fuel pile includes moving the biomass distribution member through the fuel pile beneath the feed tube terminus. More preferably, the biomass distribution member is moved through the fuel pile at intervals of 1-10 minutes, preferably 2 minutes.

In further embodiments, the method of making product gas includes the further step of igniting the product gas before it is removed from the reactor chamber.

Preferably, the method further includes the step of extracting any charcoal created from the reaction chamber.

According to a further embodiment there is provided the product gas produced using the above method as a gaseous fuel stream for a carbon dioxide capture and storage system.

According to a further embodiment of the invention, there is provided a method for the production of charcoal in an updraft gasifier, the method including;
a) introducing biomass fuel into a substantially hollow vertical feed tube extending into a reactor chamber to terminate at a feed tube terminus within the chamber to produce a fuel pile within the chamber;
b) introducing a reaction gas from below the fuel pile to react with the fuel in the pile to produce a charcoal;
c) continuously maintaining the shape of the fuel pile within the reactor using a biomass distribution member to enforce the shape of the fuel pile;
d) removing the charcoal from the reactor chamber;
   wherein steps a)-d) are continuously repeated, either simultaneously or individually.

Preferably, the reaction gas is air.

In further embodiments there is provided a method for the simultaneous production of charcoal and product gas in an updraft gasifier, the method including;
a) introducing biomass fuel into a substantially hollow vertical feed tube extending into a reactor chamber to terminate at a feed tube terminus within the chamber to produce a fuel pile within the chamber;
b) introducing a reaction gas from below the fuel pile to react with the fuel in the pile to produce a charcoal and a product gas;
c) maintaining the shape of the fuel pile within the reactor using a biomass distribution member to enforce the shape of the fuel pile;
d) removing the product gas and charcoal from the reactor chamber;
   wherein steps a)-d) are continuously repeated, either simultaneously or individually.

In further preferred embodiments there is provided a method for the production of product gas or charcoal using the updraft gasifier as described above.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 shows an overview of the reaction inside the updraft gasifier of the present invention;

FIG. 2 shows a perspective cross section of the gasifier in a one embodiment of the invention;

FIG. 3 shows a side cross section of the gasifier of FIG. 2 showing the biomass distribution member in the embodiment of FIG. 1 embodiment;

FIG. 4 shows a side cross section of the gasifier showing the gas input means in one embodiment of the invention;

FIG. 5 shows a top view of the gasifier of FIG. 2;

FIG. 6 shows a top cross section of the gasifier of FIG. 1 with the baffle feature;

FIG. 7 shows a perspective cross section of the gasifier in an alternative form of the invention;

FIG. 8 shows a side cross section of the gasifier of FIG. 7;

FIG. 9 shows a close up side cross section of the feed tube and biomass distribution member of the gasifier of FIGS. 7 and 8;

FIG. 10 shows a close up cross sectional perspective view of the rotating door mechanism and char extraction mechanisms in one embodiment of the invention;

FIG. 11 shows a graph of gasifier output with a continuous fuel cake inside the receiving portion of the reactor;

FIG. 12 shows the gasifier output when operating with a manual biomass distribution member demonstrating fuel cake breaking and forming; and

FIG. 13 shows the gasifier output with an automated biomass distribution member enforcing the pile shape every two minutes.

### DETAILED DESCRIPTION OF PREFERRED EMBODIMENTS OF THE INVENTION

The gasifier of the present invention has been designed for the production of a product gas in the form of synthesis gas, and charcoal that may be used for a variety of purposes. While updraft gasifiers have been known for many years, the gasifier described herein is designed for automated, small scale use and to effectively process biomass feedstock having a wide variation in size, moisture content and organic make up as well as providing the ability to generate highly devolatilized charcoal as a by-product.

One intended use of the gasifier described herein is for use with the carbon dioxide capture and storage system described in PCT patent application WO2018164589, a carbon dioxide system for use in commercial greenhouses. The gasifier of the present invention has been developed to operate with minimal operator input and is adapted to consume approximately 100-3000 kg of dry weigh equivalent biomass/day.

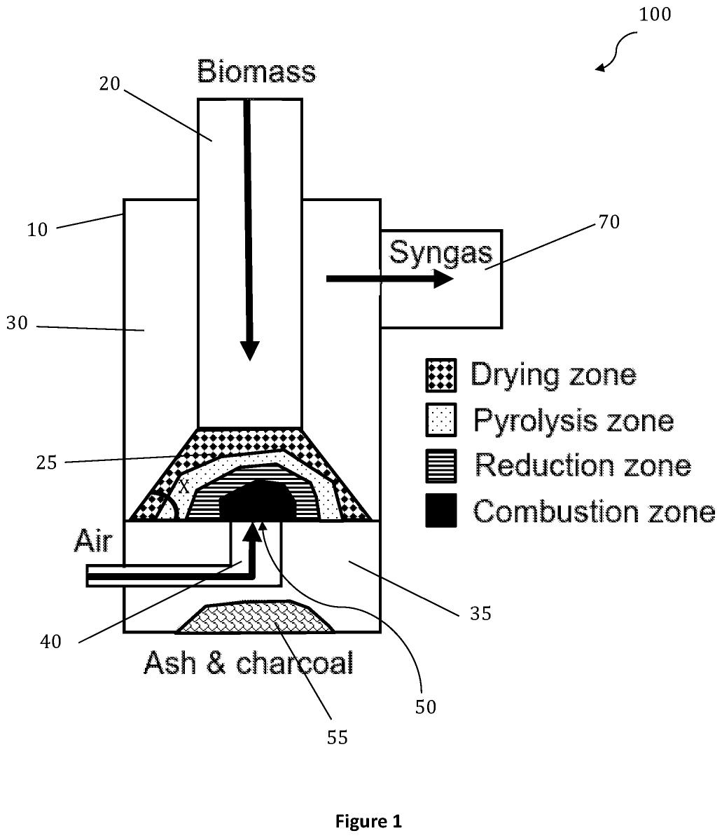

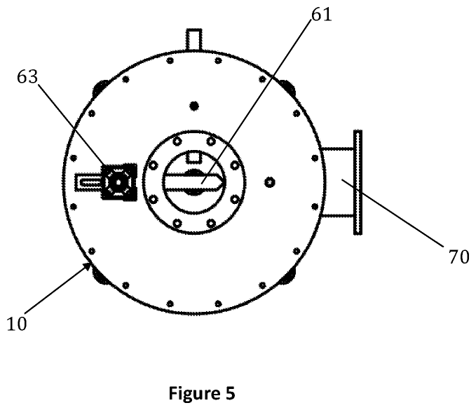

The updraft gasifier is described below with further reference to FIGS. 1-13.

FIG. 1 shows an overall schematic of the reaction processes taking place within the gasifier 100. Biomass is introduced into gasifier 100 through feed tube 20, the biomass forming a pile 25 beneath feed tube 20 within a receiving portion 30 of the reactor chamber 10. Air or other oxidising reaction gases (reaction gases such as air, steam, flue gas, low oxygen gases) are introduced to the base of pile 25 through gas input means 40, creating a combustion zone within pile 25.

Combustion of carbon in the biomass with oxygen creates carbon dioxide, which is then reduced to produce CO and H₂ with some CH₄. Following reduction of the biomass, pyrolysis occurs, thermally decomposing the biomass into charcoal. Biomass in the outer layer of pile 25 undergoes drying following the increase in heat and production of hot synthesis gases (product gases). Biomass held within feed tube 20 is also heated by the surrounding gas produced, decreasing the moisture level in the biomass as it moves down the feed tube towards pile 25.

As biomass is combusted, ash and charcoal produced fall through an aperture 50 beneath pile 25 into base portion 35 of reactor 10. Product gas produced rises and exits reactor chamber 10 via exit port 70.

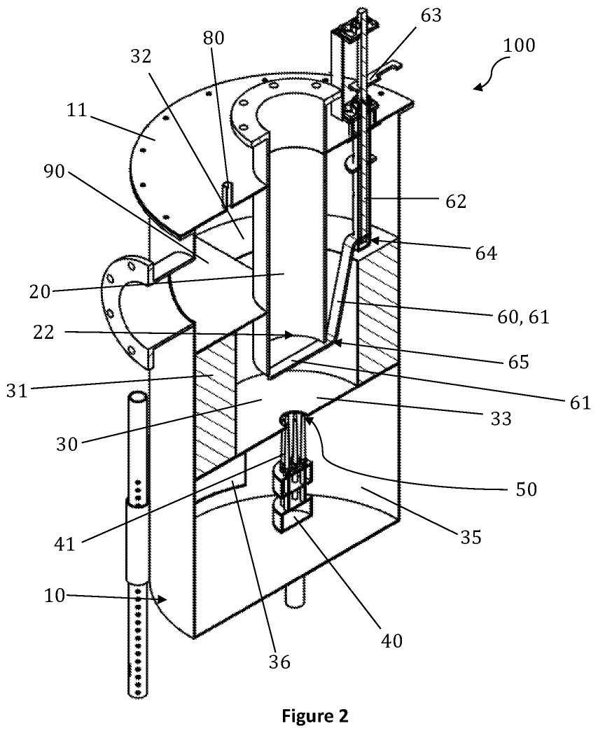

FIGS. 2-6 show the gasifier 100 in one preferred embodiment. Gasifier 100 includes a reactor chamber 10 divided into a receiving portion 30 and a base portion 35 located directly beneath receiving portion 30. Receiving portion 30 includes thermal insulation 31 around the chamber walls to reduce heat loses during the gasification process. The thermal insulation may be ceramic wool, brick or other suitable insulating material that can withstand high temperatures.

Receiving portion 30 is separated from base portion 35 by a shelf 33. Aperture 50 is centrally located in shelf 33 to fluidly connect base portion 35 and receiving portion 30. Aperture 50 has a dual role in this embodiment, allowing reaction gases to be introduced into receiving portion 30 from gas input nozzles 41 in base portion 35, and enabling ash, slag and charcoal produced following gasification of the biomass to fall into base portion 35, where it can be removed through a door 36.

In the preferred embodiment shown, aperture 50 is centrally located, and aligned with the vertical axis of elongate feed tube 20 that extends into receiving portion 30. In alternative embodiments, there may be multiple apertures located in shelf 33, either to increase the ability to remove ash, which forms directly above the air inlets in the combustion zone, to allow for multiple gas inputs or to provide apertures in different regions of shelf 33 to allow for extraction of different products, such as the removal of charcoal formed in non-aerated zones.

The apertures may have a wide range of shapes as sizes as necessary for a particular design, however in the embodiment shown aperture 50 is circular, with a diameter of 90 mm.

In order to effectively remove ash without destabilising biomass pile 25, aperture 50 is preferably between 50 mm-200 mm. If larger apertures are required, a porous grate may be place over the aperture to avoid larger particles falling into base portion 35. Limiting the size of aperture 50 in this embodiment has advantages over larger grate coverings, by reducing the amount and size of ash that can fall through aperture 50. This in turn results in a build-up of a residue slope inside the base of receiving portion 30, the slope then acting to direct ash down towards aperture 50.

The size of aperture 50 directly effects the outputs of the gasifier and may be sized to suit the desired system requirements. Increasing the size of aperture 50 increases the outflow of ash into the base portion, which in turn controls the flow of fuel entering the receiving portion 30 from feed tube 20. The size of aperture 50 also controls the amount of air that may be injected from base portion into the combustion zone, effectively defining the area where combustion will happen within the fuel pile and areas that are non-aerated, or “dead zones”.

To support removal of ash or charcoal from the receiving portion 30, shelf 33 may further include additional apertures including a mechanical opening such as a hatch, door, rotary valve or slide gate valve that may be opened and closed to enable additional charcoal or ash extraction from receiving portion 30 when required. Charcoal forms in the non-aerated or “dead zones” of receiving portion 30 and apertures for removing charcoal may be positioned in locations of the shelf where charcoal build-up is most prevalent, such as the corners or the receiving portion 30 or areas away from the central aeration zone. Similarly, a mechanical opening to remove ash will be located near the combustion zone (typically more centrally), where ash is formed over charcoal.

Mechanical operation of any covered apertures or doors/hatches is preferred, so that the time charcoal or ash is spent devolatilizing in the receiving portion 30 can be controlled and charcoal or ash removed on demand.

The ash or charcoal collected in base portion 35 is manually emptied through an access hatch 36 in a side wall of the base portion 35. Emptying the ash volume manually requires the gasifier to not be operating.

An automatic ash or charcoal removal system (not shown) may be employed to provide for removal of ash or charcoal from the base portion, even when the gasifier is in operation. Additional amounts of reaction gases may optionally be added to base portion 35 for further activation of the charcoal collected in base portion 35 before removal.

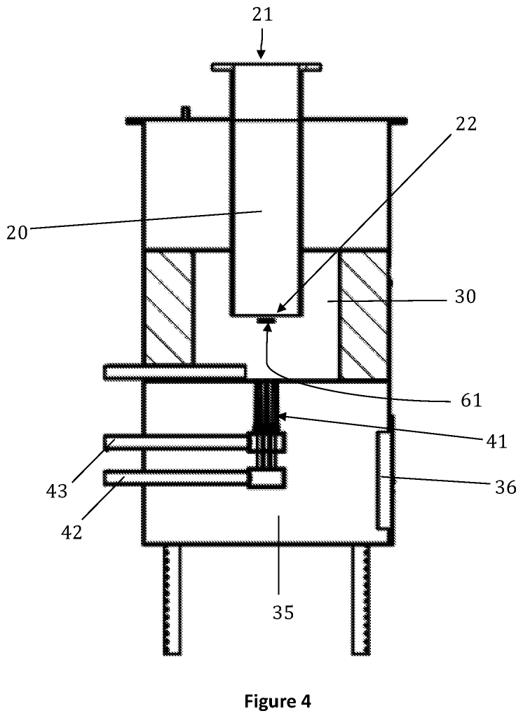

Reaction gases are introduced into gasifier 100 via gas input means 40. Reaction gases may be air, steam, oxygen or other oxidising gases and are introduced into base portion 35 via one or more gas input conduits. As seen in FIG. 4, in a preferred embodiment reaction gas is introduced into the gasifier using two conduits 42 and 43. Gas introduced through conduits 42 and 43 enters the gasifier through injection nozzles 41, the injection nozzles located directly below aperture 50 and orientated such that the reaction gas is forced upwards through aperture 50 into biomass pile 25.

In the preferred arrangement of injection nozzles as shown in FIGS. 2 and 4, a first conduit 42 supplies a three central injection nozzle and second conduit 43 supplies six injection nozzles positioned in a circle around the central injection nozzle. The number, shape, size, placement, and gas speed of the injection nozzles determine the size and shape of the combustion zone inside the gasifier. As such, it is envisaged that a range of gas input designs may be applied to gasifiers of the current invention depending on the output gas requirements.

Biomass is introduced into gasifier 100 via feed tube 20. Feed tube 20 is vertically aligned within the gasifier and extends into receiving portion 30 of reactor chamber 10. Feed tube 20 extends into the gasifier ending at a feed tube terminus 22 situated 320 mm from the base shelf. Feed tube terminus 22 terminates at a position suitable to ensure the level of biomass inside the gasifier is at a suitable height to accomplish all four stages of gasification as shown in FIG. 1, while not excessively cooling the product gas produced in the reactor chamber. Biomass entering feed tube 20 is gravity fed into receiving portion 30, so the feed tube is preferably vertical, or angled from the vertical axis an amount that enables the biomass to move down the feed tube under its own weight. This angle may change depending on the size, weight and moisture content of the biomass used, but may be between 1-45 [symbol] from vertical, and more likely 1-10 [symbol] from vertical.

Feed tube 20 is a hollow tube, preferably cylindrical that receives biomass from a first end 21 located outside reactor chamber 10. The preferred diameter of the feed tube is 200 mm, but it may be a range of diameters depending on the size of the gasifier and type of biomass used, for example 100 mm-500 mm in diameter. Feed tube 20 may also be an elongate tube with different shaped cross sections, for example square, rectangular, D-shaped, oval, triangular, hexagonal, octagonal or oval. The diameter or cross-sectional shape of the feed tube may also change along the length of the feed tube, helping to increase or decrease biomass flow at different regions of the feed tube.

As biomass enters feed tube 20, it falls to create pile 25 in the base of receiving portion 30. Once the biomass pile reaches the height of feed tube terminus 22, feed tube 20 fills up with biomass. As air is introduced through gas input 40, gasification of the biomass reduces the size of pile 25, ash and slag falls into base portion 35 and the pile 25 decreases in size from the base of the pile, the pile being continuously topped up from gravity fed feed tube 20.

Feed tube 20 may extend above the gasifier as required. In the embodiments shown, feed tube 20 extends from the top surface 11 between 150 mm-500 mm. The portion of feed tube 20 external to receiving portion 30 provides an area for placement of sensors, such as a biomass level sensor that monitors the amount of biomass available to optimise the gravity feed process. Such sensors may include, but are not limited to ultrasonic, piezoelectric or optical sensors.

While sensors may be mounted internally, extending the feed tube 20 above the gasifier provides much easier access to the sensors, as well as protecting the sensors from excessive heat.

Biomass may be introduced into feed tube 20 at point 21 through a range of known means such as hoppers, screw conveyors or vibratory conveyors for example.

The shape of pile 25 formed as biomass exits feed tube 20 effects the gasification output. By keeping the shape of the pile consistent throughout the gasification process, gas production remains steady without the need for advanced controls.

To enforce a consistent shape of biomass pile 25, a biomass distribution member 60 is used. Without the biomass distribution member, as the biomass exits the feed tube 20 there is a risk of caking occurring between the feed tube terminus and pile 25, wherein the biomass forms a lump or mass beneath the feed tube, rather than flowing freely into the receiving portion 30. When caking occurs, the overall shape of pile 25 is altered, allowing the gas from the combustion and reduction zones to bypass the pyrolysis and drying zones. The bypassing of the pyrolysis and drying zones means the biomass reaching the lower zones is wetter and the produced gas is not filtered through a pyrolyzed layer—which gives a less reducing product gas composition (more CO₂ and H₂O instead of CO and H₂). Some biomass will be more prone to caking that others, however to enable to effective use of a range of different biomass types, the biomass distribution member enables a consistent pile shape regardless of biomass characteristics.

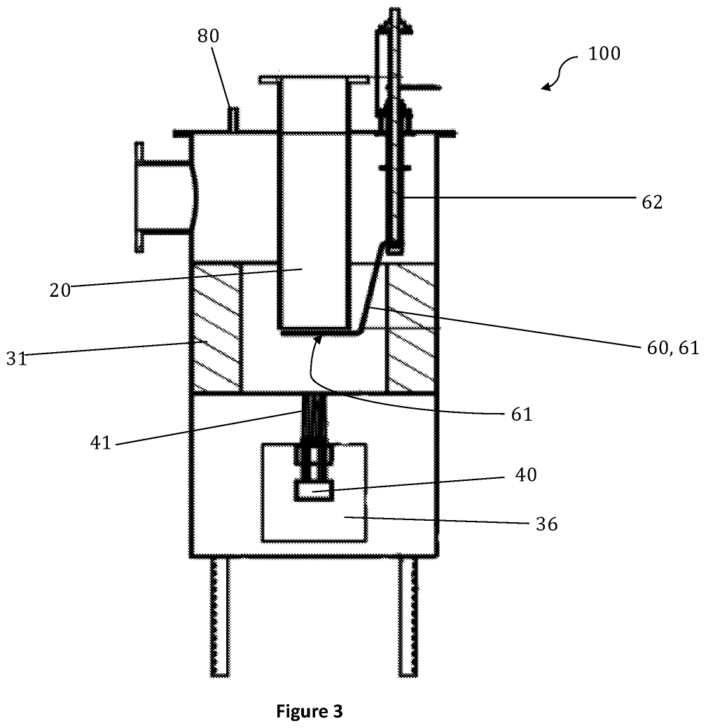

A biomass distribution member 60 in a preferred embodiment can be seen in FIGS. 2 and 3. In use, preferred distribution member 60 is moved beneath feed tube terminus 22, preventing biomass from clumping together and forming a cake at the top of pile 25. Preferably member 60 is adapted to move back and forth in a horizontal plane, perpendicular to the vertical axis of the feed tube. Movement of distribution member 60 maintains pile 25 with sloped sides that angle downward from feed tube terminus 22 to the walls of receiving portion 30, as shown as X in FIG. 1.

The preferred shape of pile 25 is a frustoconical shape with the upper surface of fuel pile 25 maintained to have angled sides of 40-55 [symbol] from horizontal shelf 33. In order to maintain the pile shape distribution member 60 is preferably moved through or partially though the fuel pile at intervals of 1 seconds-10 minutes, preferably 2 minutes for a full revolution. Partial revolutions may be employed within a shorter time frame, or full revolutions with a greater lag between them, as required by the biomass type and combustion rate.

In a preferred embodiment, the biomass distribution member 60 includes an angled blade portion 61 and a vertical shaft 62 rotatable around the vertical axis of said shaft, the shaft 62 extending into the receiving portion of the chamber parallel to the vertical feed tube. Blade portion 61 is connected to shaft 62 within receiving portion 30, the blade portion shaped such that the blade extends from the shaft at an angle such that when the shaft is rotated, the blade portion is also rotated and moved through fuel pile 25 beneath the feed tube terminus 22. Rotation of the distribution member 60 is actuated by a driver 63, positioned outside reactor chamber 10 and the rotation preferably occurs around a fulcrum offset from the central vertical axis of the reactor chamber.

As seen in FIG. 2, vertical shaft 62 extends vertically into receiving portion 30 and is mounted on a ledge 32 of the inner walls of receiving portion 30. Shaft 62 is parallel to and offset from the central vertical axis of feed tube 20 and is connected to blade 61 at or near first end 64 of shaft 62, such that rotation of shaft 62 by external actuator 63 rotates blade 61.

Blade 61 is preferably shaped as a flat, elongate paddle having opposing, substantially planar surfaces with flat or tapered edges. The elongate paddle includes a bend 65 along its length to enable at least a portion of blade 61 to be positioned horizontally beneath the feed tube terminus. Preferably, the portion of the blade 61 beneath the feed tube terminus is equal to or greater than the diameter of the feed tube terminus 22.

Biomass distribution member 60 is preferably mounted between 5 mm-50 mm beneath feed tube terminus 22, preferably less than 10 mm, maintaining the pile height above 200 mm. In practice, the space between the biomass distribution member 60 and feed tube terminus may change depending on the size of the biomass pieces. For example, larger pieces will require a greater space between the two components to ensure they can operate without jamming.

In alternative embodiments, the biomass distribution member 60 may take the form of any device able to effectively move through the fuel pile to maintain the shape of pile 25. Blade 61 may have multiple bends to enable successful pile distribution, and may be of differing lengths and shapes depending on where it is mounted and how it is actuated.

In further embodiments not shown, the biomass distribution member may take the form of a retractable shelf, pipe, tube or blade that extends and retracts from the side wall of receiving portion 30, disrupting the biomass pile to retain the required shape.

The biomass distribution member may take the form of a tube or U-shaped, D-shaped or V-shaped channel. This embodiment allows for cool air to be passed through the biomass distribution member, cooling the pile while maintaining pile shape.

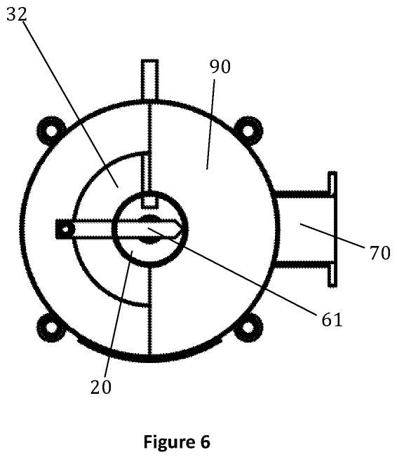

To increase the temperature of the outgoing product gas, gasifier 100 includes an ignition means 80 to ignite the gas in the top of the receiving portion 30 before it exits at exit port 70. FIG. 6 shows a top cross section view of the gasifier showing baffle 90.

The product gas may be mixed with hot air to partially combust the tar in the gas. To improve the product gas-air mixing, baffle 90 is located within receiving portion 30. Baffle 90 forces the product gas to move through a limited opening before exiting the gasifier and improves gas movement through the biomass pile, providing an improved overall gas composition. In preferred embodiments, baffle 90 is parallel to shelf 33 and extends between the feed tube 20 and inner walls of receiving portion 30, covering between 65-35% of the horizontal cross-sectional area of receiving portion 30, preferably around 50%.

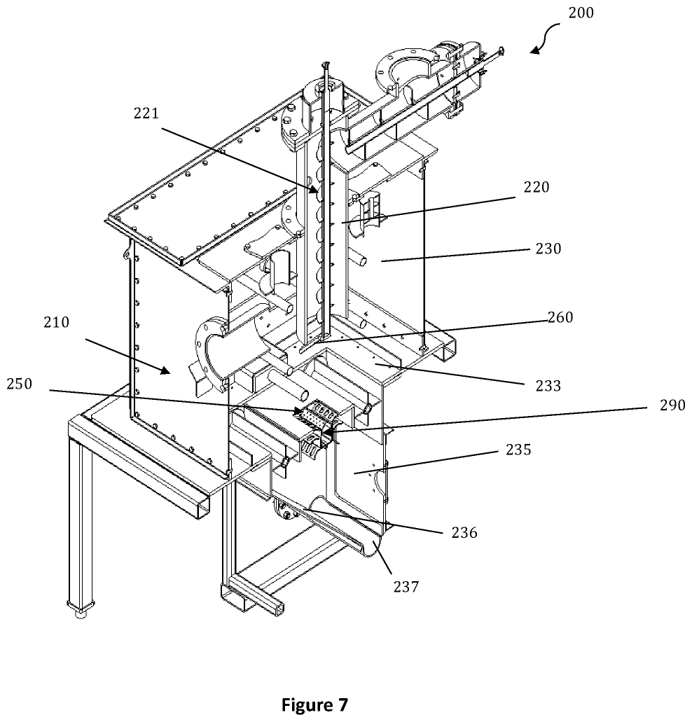

FIGS. 7-10 show gasifier 200 in an alternative embodiment of the invention. In the embodiment shown here gasifier 200 includes a reactor chamber 210 divided into a receiving portion 230 and a base portion 235 located directly beneath receiving portion 230, separated by a shelf 233 (partially shown).

In this embodiment base portion 235 includes a sloping wall 236 to aid extraction of char through the bottom of base portion 235 at exit 237, using either a screw auger or manual extraction means.

As with aperture 50 in gasifier 100, aperture 250 is centrally located in shelf 233 to fluidly connect base portion 235 and receiving portion 230. In gasifier 200, aperture 250 is larger and in gasifier 100, and a rotating door mechanism 290 is positioned beneath aperture 250 to both support the biomass pile, while still allowing the input of gas into the receiving portion 230, and allowing the removal of small materials such as ash or char down into the base portion 235.

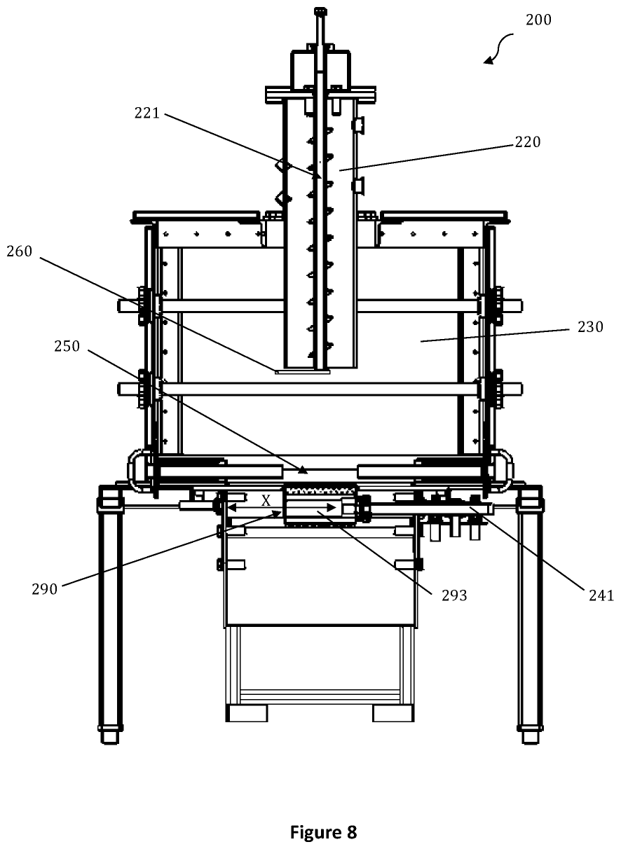

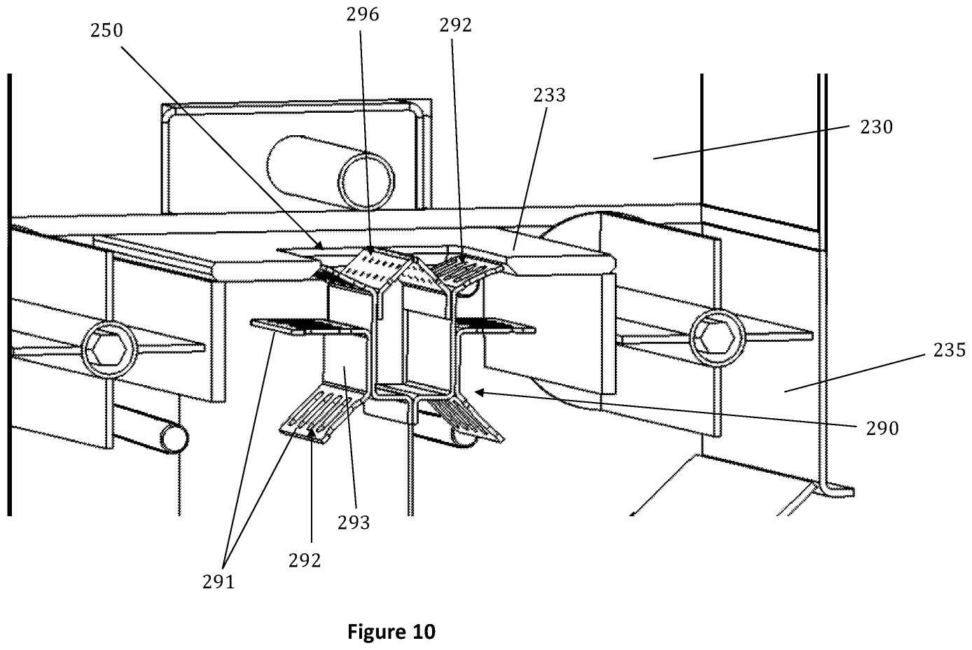

Rotating door mechanism 290 is preferably positioned at least partially below the aperture 250 and includes a hollow body 293 with a plurality of radially oriented fins 291, the mechanism 290 being rotatable around a central axis X (FIG. 8) extending through the centre of hollow body 293. Rotating door mechanism 290 may be manually or mechanically rotated using a hydraulic or pneumatic ram, or motor, and as rotating door mechanism 290 is rotated it is moved between a closed position (FIG. 10) where aperture 250 is covered by fins 291 and a portion of hollow body 293, through a partially open, moving position whereby aperture 250 is temporarily partially opened and fins 291 move through the biomass, creating movement of the material and improving gas flow, before being repositioned in a closed position once again following either a 360 degree rotation or a smaller rotation in either direction and then in the reverse direction to return to the original position. Rotating door mechanism 290 may be rotated sporadically as needed to reduce clogging or improve gas flow, or may be regularly rotated or partially rotated at intervals of 10, 20, 30, 40, 50, 60, 70, 80, 90, 100, 110, 120, 150, 180 seconds for example.

As seen in one embodiment shown in FIG. 10, the six fins 291 optionally include apertures 292 to allow gas, ash or char to pass through the fins. These apertures may be a variety of sizes across the different fins, with smaller apertures only allowing gas and small ash particles to pass through while supporting the biomass, and larger apertures allowing more char and ash to move into base portion 235.

Hollow body 293 includes apertures 296 on a portion of the body walls that act as gas inlet nozzles, directing gas received within hollow body 293 from a gas inlet means, into receiving chamber 235. In order for gas to be directed into the receiving chamber, hollow body 293 is positioned such that apertures 296 are oriented to direct gas into the receiving chamber above, with remaining walls of the hollow body remaining solid to ensure gas pressure is maintained. When rotating door mechanism 290 is in operation, the rotation is controlled to ensure apertures 296 are correctly positioned when gas is introduced through the gas inlet means. The size and pattern of the apertures may be tailored to a particular gasifier size or biomass type (for example).

FIG. 8 shows a side cross section of rotating door mechanism 290, with input gas being introduced into the hollow body 293 of rotating door mechanism 290 through gas input 241, before entering receiving portion 230 through apertures 296 within hollow body 293 of rotating door mechanism 290, located beneath aperture 250.

It should be understood that the rotating door mechanism 290 may take other shapes, with a varying number of fins having different shapes and sizes from those shown, as may be required for the different properties of biomass being used. The shape of the rotating door mechanism 290 may have order 1, 2, 3, 4, 5, 6, 7, 8, 9 or 10 rotational symmetry, allowing different degrees of rotations to provide closing of the aperture depending on the shape of the mechanism and number of fins. Rotating door mechanism 290 is shaped such that aperture 250 may be closed or partially closed following the positioning of a portion of rotating door mechanism 290 within aperture 250.

In gasifier 200, ash or charcoal may be removed from the “dead zones” of the receiving portion 230 using one or more rotating extractors 280, as seen in FIG. 10. In the embodiment shown by gasifier 200, the reactor chamber is substantially cuboid in shape and two extractors 280 are positioned on opposing sides of the chamber, forming a movable barrier between the receiving portion 230 and base portion 235. The gasifier may use any number of extractors as required by the size and shape of the gasifier.

In the form shown, extractors 280 include a central elongate body 281 and base 286. Elongate body 281 is preferably hollow and is adapted to receive a rotating means that is operable to rotate extractors 280 around a central axis through elongate body 281. Extending radially from elongate body 281 are fins 282, 283, 284 and 285. The fins are preferably shaped as flat panels extending from a first end of body 281 proximal base 286 to a second end of body 281, the fins running substantially the length of elongate body 281. Fins 282 and 283 oppose each other on a first plane, and fins 284, 285 oppose each other on a second plane, the first plane substantially at right angles to the second plane, such that in cross-section, the fins form a cross shape with body 281 at the centre.

The fins are sized such that when one pair of fins 282, 283 or 284, 285 is in a horizontal position, the fins fill an aperture between the receiving portion and the base portion, the top surface of the horizontal fins providing a surface to support the weight of charcoal or biomass in the receiving chamber.

Rotational operation of extractors 280 may be manual or automatically driven using standard processes such as a motor, pneumatic or hydraulic ram. In the embodiment shown, extractors 280 may be manually turned by handles 285 (FIG. 8) located on the exterior of the gasifier when char needs to be extracted from the reactor. When rotated, the rotation of central body 281 rotates the fins, and char built up on top of the horizontal fins is dropped into the base portion 235 of the reactor as the extractor rotates through 90 degrees. Rotation of the extractor is then stopped when two fins are in a horizontal position, providing a barrier between the receiving portion and base portions of the reactor, and rotated again when further char has built up on the top surface of the horizontal fins and needs to be removed. As would be understood by a person skilled in the art, stopping the rotation of the extractor 280 when fins are not in a horizontal position may leave a space for char to fall continuously into the base chamber. The positioning of the fins can be selected by the amount of rotation to control the movement of char from the receiving portion to the base portion as required by the system at a particular time.

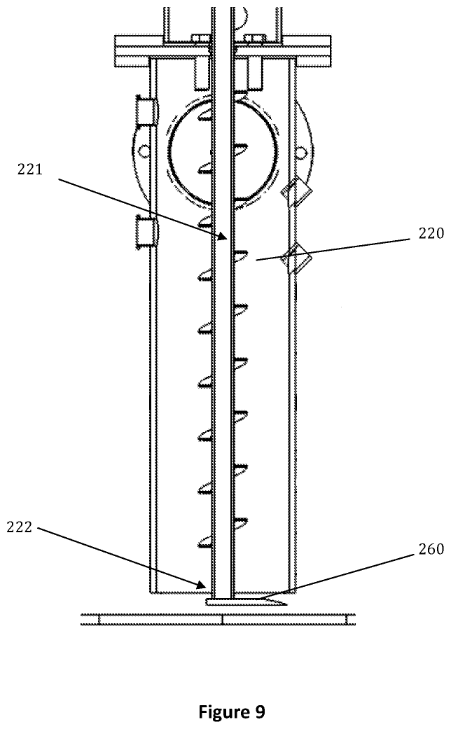

Gasifier 200 further shows an alternative embodiment for the operation and position of the biomass distribution member as seen in FIG. 9. In gasifier 200, feed tube 220 includes a screw feed 221 centrally located within the feed tube 220. In use, the screw feed rotates in an upward direction to prevent clogging of the screw feed as biomass falls through feed tube 220. Biomass distribution member 260 is a flat paddle attached directly to the end of screw feed 221, and as screw feed 221 rotates, biomass distribution member 260 rotates beneath the feed tube terminus 222, maintaining pile size and shape. As with the alternative embodiment shown earlier, the biomass distribution member 260 may have a range of sizes and shapes such as a blade, flange, cross or V-shape and may extend at right angles from the central axis of the screw feed 221, or may be angled at anywhere from 90° to 160° to influence the shape of the pile required beneath the feed tube terminus.

The biomass distribution member 260 may also be interchangeable with members of different sizes and shapes.

Gasifier 200 further includes service tubes 270 and 271 extending through the receiving portion of the reactor chamber. When in operation, tubes 270 extend through the upper portion of the receiving chamber containing hot gas, and tube 271 extend through the combusting biomass pile. Tubes 270 and 271 may be used to introduce hot air to increase combustion, or to increase the temperature of the gases in the upper portion of the chamber. Port 274 acts as an ignition port in the base of the receiving chamber in one embodiment of the invention.

It should be understood gasifier 100 and gasifier 200 are two examples of the same invention, and features from each of the examples may be used interchangeably between the two embodiments as required. These examples are not intended to be limiting and are intended to show a number of ways the gasifier of the present invention may be configured.

In use, the gasifier may be optimised to produce synthesis gas as a product, or charcoal, or both, or may be set in full combustion mode, where the biomass feeding is stopped and the biomass pile allowed to reduce below 200 mm. For optimised production of synthesis gas, feed tube 20 is kept full of biomass, to allow continuous self-feeding of fuel to the combustion zone. The rate of combustion is determined by regulating the incoming reaction gas and the production of specific gases is optimised by maintain a consistent pile shape using the biomass distribution member 60.

When charcoal making is optimised, the pile dead zone is emptied of charcoal every 6 to 24 hours, depending on the quality of charcoal required/To obtain a highly devolatilized charcoal, the pile is taken into combustion mode before emptying the charcoal.

### EXAMPLE

The difference in synthesis gas production was compared using the gasifier 100 of the present invention with and without the use of the biomass distribution member to enforce the desired pile shape and prevent caking with the reactor 10.

Woody biomass was loaded from the top to fill the feed tube 20. The feed tube is kept at least partially full to ensure continuous biomass supply to the gasification process. 5-25 m³/hr of air is injected through nozzle 41 in the base portion of the reactor chamber. The lowest air flow is used during the start-up of the gasifier, the medium ranges for dry (15% moisture) wood chips, and the high range for wet (30% moisture) wood chips. For this amount of air the gasifier uses 2-12 kg dry equivalent biomass/hr (2:1 air:biomass). For dry biomass the outgoing syngas temperature is around 250 C, for wet biomass the temperature is around 80 C.

The gas produced by the gasifier is shown to be closely related to the shape of the biomass pile inside the gasifier. The pile shape is enforced by the biomass distribution member, demonstrating the distribution member is essential for producing the desired syngas composition. The distribution member also keeps the synthesis gas temperature stable as the pile shape is stable.

TABLE 1
Gas production comparison with and without use of
biomass distribution member

| Gas | With paddle (%) | Without paddle (%) |
|---|---|---|
| CO | 25.4 | 15 |
| CO2 | 8.6 | 15 |
| CH4 | 2.5 | 3 |
| CnHm | 0.1 | 0.1 |
| O2 | 1.3 | 2 |
| H2 | 6.2 | 6 |
| N2 | 55.9 | 59.9 |

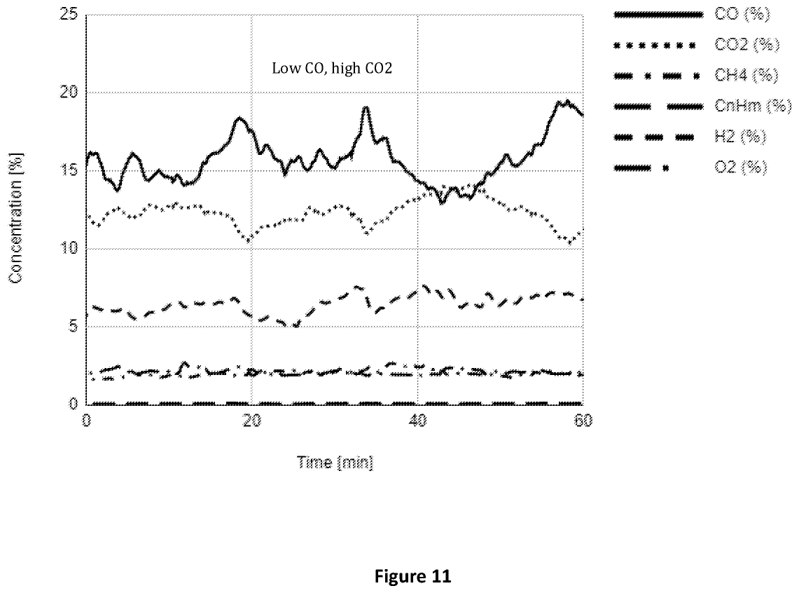

FIGS. 11, 12 and 13 show results graphs of synthesis gas outputs under different biomass caking conditions.

FIG. 11 shows the gasifier operating with a continuous cake inside giving low CO and CO₂ content. Variations in gas composition are comparatively large, which is likely due to minor occasional cake breakages.

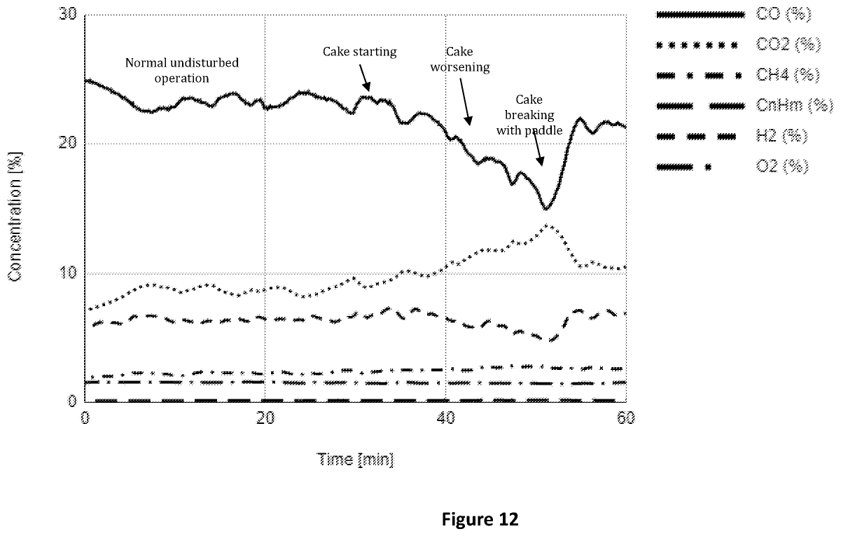

FIG. 12 shows the gasifier operating with a paddle being manually operated to see the effect of cake forming and breaking. CO production is high and CO₂ production is low. As the cake is being formed the CO drops and production CO₂ increases. Using the paddle to break the cake returns the syngas composition to normal composition.

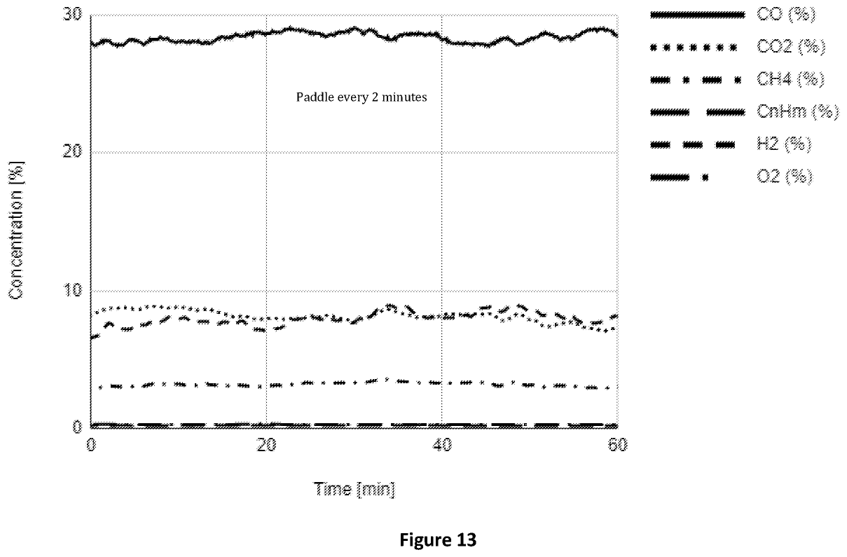

FIG. 13 shows the gasifier in operation with the biomass distribution member automatically actuated every two minutes, preventing the biomass from caking. The synthesis gas is produced in a very steady composition with high levels of CO due to a consistent pile shape.

When gasifier is optimised for charcoal production, the gasifier conditions may be altered by decreasing the amount of oxygen being input into the gasifier, slowing the heating of the biomass within the receiving portion of the reactor. As charcoal is produced at the edges of the combustion zone, altering the shape of the receiving portion of the reactor, position of the air injection nozzles and/or pile shape can optimise the charcoal output within the gasifier. Gasifier 100 may include a charcoal hatch in the bottom of the combustion zone.

In full combustion mode, feed to the feed tube is stopped, allowing the pile inside the gasifier to reduce until all the biomass is in the combustion zone. This mode may be used to pre-heat the gasifier insulation, or to burn off tar build up on the inside of the gasifier, as the combustion mode results in very hot energy rich synthesis gas.

The gasifier of the present invention has several distinct advantages over known updraft gasifiers. By using a gravity fed feed tube and automatically maintaining a consistent pile shape of biomass fuel within the reactor chamber, a continuous and steady production of synthesis gas can be achieved by controlling only the reaction gases input into the reactor. This removes the need for monitoring and maintaining compulsory feeding mechanisms into the reactor and allows for the use of a wide range of different biomass shapes, sizes and moisture levels. The extension of the feed tube into the reactor increases the ability to dry incoming biomass with the surrounding synthesis gases prior to combustion, increasing gas production speed and gas output.

The entire disclosures of all applications, patents and publications cited above and below, if any, are herein incorporated by reference.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. An updraft gasifier, the gasifier including;
a reactor chamber, the reactor chamber adapted to receive an amount of biomass fuel in a receiving portion of the reactor chamber;
one or more reaction gas input means located in a base portion of the reactor chamber, the base portion located below and fluidly connected to the receiving portion of the reactor chamber;
a hollow feed tube extending into the receiving portion of the reactor chamber to terminate at a feed tube terminus within the receiving portion of the reactor chamber;
one or more product gas output means located at or near the top of the receiving portion of the reactor chamber; and
wherein the gasifier further includes a biomass distribution member within the receiving chamber, the biomass distribution member positioned to enable at least a portion of the biomass distribution member to be moveable beneath the feed tube terminus.

2. The updraft gasifier of claim 1, wherein the reactor chamber includes a shelf separating the receiving portion and the base portion, the shelf including one or more apertures fluidly connecting the receiving portion and the base portion.

3. The updraft gasifier of claim 2, wherein the shelf includes an aperture located beneath the centre of the feed tube terminus.

4. The updraft gasifier of claim 3, wherein the gasifier includes a cover associated with the aperture such as a hatch, grate, grille or door that may be fully or partially opened to allow material to move between the receiving portion and base portion or fully or partially closed to prevent or restrict movement of material between the receiving portion and base portion.

5. The updraft gasifier of claim 4, wherein the cover is a rotating door mechanism positioned at least partially below the aperture.

6. The updraft gasifier of claim 5, wherein the rotating door mechanism is rotatable around a central axis and includes a hollow body with a plurality of fins extending radially outward from the hollow body.

7. The updraft gasifier of claim 6, wherein one or more of the plurality of fins include one or more apertures.

8. (canceled)

9. The updraft gasifier of claim 2, wherein the shelf includes one or more additional apertures including a mechanical opening such as a hatch, door, rotary valve or slide gate valve that may be opened and closed to enable additional charcoal or ash extraction from the receiving portion of the reactor.

10. The updraft gasifier of claim 9, wherein the mechanical opening is a rotating extractor connecting the receiving chamber and base chamber.

11-12. (canceled)

13. The updraft gasifier of claim 1, wherein the feed tube includes a central vertical screw feed.

14. The updraft gasifier of claim 1, wherein the receiving portion of the reactor chamber includes a baffle for directing gas flow within the receiving portion.

15. (canceled)

16. The updraft gasifier of claim 1, wherein the biomass distribution member is movable in a horizontal plane, perpendicular to the vertical axis of the feed tube.

17. The updraft gasifier of claim 13, wherein the biomass distribution member is connected to the central vertical screw feed in the feed tube.

18. The updraft gasifier of claim 1, wherein the biomass distribution member pivots around a fulcrum offset from a central vertical axis of the reactor chamber.

19. The updraft gasifier of claim 1, wherein the biomass distribution member extends and retracts from a position offset from a central vertical axis of the reactor chamber.

20. The updraft gasifier of claim 1, wherein the biomass distribution member includes a vertical shaft rotatable around the vertical axis of said shaft, the shaft extending into the receiving portion of the chamber parallel to the vertical feed tube and a blade portion connected to the shaft, the blade portion shaped and positioned such that the blade extends from the shaft at an angle such that when the shaft is rotated, the blade portion is moveable beneath the feed tube terminus.

21. The updraft gasifier of claim 20, wherein the blade portion is an elongate paddle.

22. The updraft gasifier of claim 20, wherein the blade portion is angled at one or more locations, such that a region of the blade is positioned horizontally beneath the feed tube terminus.

23. The updraft gasifier of claim 1, wherein the reaction gas input means is one or more gas injection nozzles centrally located in the base portion of the reactor chamber.

24-35. (canceled)

36. An updraft gasifier, the gasifier including;
a reactor chamber including a receiving portion and a base portion, the base portion located below and fluidly connected to the receiving portion;
one or more reaction gas input means located in the base portion of the chamber;
a hollow feed tube for receiving biomass, the hollow feed tube extending into the receiving portion of the chamber to terminate at a feed tube terminus within the receiving portion of the reactor chamber;
one or more product gas output means located at or near the top of the receiving portion of the reactor chamber; and
wherein the updraft gasifier further includes a biomass distribution member, the biomass distribution member positioned to enable at least a portion of the biomass distribution member to be moveable beneath the feed tube terminus to disrupt the biomass distribution.
